(19) United States
(12) Patent Application Publication
(10) Pub. No.: US 2008/0177642 A1
(43) Pub. Date: Jul. 24, 2008

(54) COMPUTER-IMPLEMENTED METHODS, SYSTEMS, AND COMPUTER PROGRAM PRODUCTS FOR RISK MANAGEMENT

(75) Inventors: Richard E. Birney, Fishkill, NY (US); David L. Johnson, Ridgefield, CT (US); Apar Kothari, Wellesley, MA (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/624,308

(22) Filed: Jan. 18, 2007

(51) Int. Cl. G06Q 40/00

(52) U.S. Cl. 705/30; 705/36 R

(57) ABSTRACT

Computer-implemented methods, systems, and computer program products for risk management are provided. A computer-implemented method includes establishing guidelines for processing commitment-related activities for an investment fund. The computer-implemented method further includes establishing criteria and threshold values for triggering events associated with the commitment-related activities. The computer-implemented method also includes applying the guidelines, the criteria, and the threshold values to data supplied by the investment fund, and determining a course of action based upon application of the guidelines, criteria, and threshold values to the data.

### BACKGROUND OF THE INVENTION

The present disclosure relates generally to risk management and, in particular, to computer-implemented methods, systems, and computer program products for managing investment risk.

Risk management refers to a process for identifying or assessing risk and developing ways to mitigate that risk. With respect to investing, risk management may include identifying investments and investment-related activities that are likely to create losses for the investment entity. Over-committing of capital funds and investing in high-risk or unstable businesses, technology, etc., are among some of the activities that may result in financial losses. Thus, managing these risks is fraught with uncertainties.

Various risk management techniques have been developed for mitigating risks associated with investments. For example, current and historical data may be gathered and used to support decision-making regarding future investments. Risk factors may be assessed and analyzed for developing an investment plan. However, this historical data, as well as identified risk factors, are not always accurate as trends associated with the data change over time and risk factor analysis can be quite subjective in nature.

What is needed, therefore, is a way to provide a disciplined approach to risk management that provides structured guidelines for managing balance sheet exposure as well as investments for a given fund.

### BRIEF SUMMARY OF THE INVENTION

Embodiments of the invention include computer-implemented methods for risk management. A computer-implemented method includes establishing guidelines for processing commitment-related activities for an investment fluid. The computer-implemented method further includes establishing criteria and threshold values for triggering events associated with the commitment-related activities. The computer-implemented method also includes applying the guidelines, the criteria, and the threshold values to data supplied by the investment fund, and determining a course of action based upon application of the guidelines, criteria, and threshold values to the data.

Further embodiments include a system for providing risk management. The system includes a host system and a risk management application and user interface executing on the host system. The risk management application performs a method via the user interface. The method includes establishing guidelines for processing commitment-related activities. The method also includes establishing criteria and threshold values for triggering events associated with the commitment-related activities. The method also includes applying the guidelines, the criteria, and the threshold values to data supplied by the investment fund, and determining a course of action based upon application of the guidelines, criteria, and threshold values to the data.

Further embodiments include a computer program product for providing risk management. The computer program product includes instructions for causing a computer to implement a method. The method includes establishing guidelines for processing commitment-related activities. The method also includes establishing criteria and threshold values for triggering events associated with the commitment-related activities. The method also includes applying the guidelines, the criteria, and the threshold values to data supplied by the investment find, and determining a course of action based upon application of the guidelines, criteria, and threshold values to the data.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a portion of system upon which risk management functions may be implemented in exemplary embodiments;

FIG. 2 is a flow diagram describing a process for managing commitment and investment activities via the risk management functions in accordance with exemplary embodiments; and

FIG. 3 is a summary sheet depicting sample data produced via the risk management functions in exemplary embodiments.

The detailed description explains the preferred embodiments of the invention, together with advantages and features, by way of example with reference to the drawings.

### DETAILED DESCRIPTION OF THE INVENTION

Computer-implemented methods, systems, and computer program products for risk management are provided in exemplary embodiments. The risk management services provide a formal process for making investments, as well as for controlling balance sheet exposure for corporations making these investments. In exemplary embodiments, the risk management services are described herein as being directed to venture capital funds; however, other types of investment funds may be used in order to realize the advantages of the invention.

The features described herein provide a disciplined approach to risk management, including establishing a threshold for a maximum level of commitment, as well as other user-defined criteria. The risk management services disclose a venture capital compliance model that includes fixed guidelines to limit balance sheet exposure of investing companies to a pre-defined level and limit new investment by establishing a threshold on maximum investment. The compliance model maintains an “evergreen” self-funded model whereby incoming distributions are used to fluid new investments. The compliance model also provides a snapshot of the impact of an investment to the balance sheet at the time of investment.

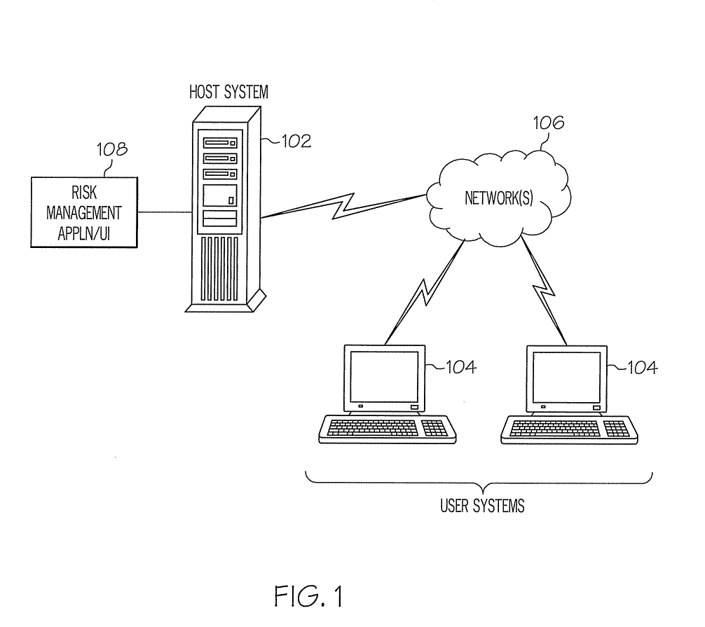

Referring now to FIG. 1, a host system 102 executes computer instructions for performing risk management functions. Risk management refers to a process for identifying or assessing risk and developing ways to mitigate that risk. With respect to investing, risk management may include identifying investments and investment-related activities that are likely to create losses for the investment entity. Over-committing of capital funds and investing in high-risk or unstable businesses, technology, etc., are among some of the activities that may result in financial losses.

The system depicted in FIG. 1 includes one or more user systems 104 through which users at one or more geographic locations may contact the host system 102. The user systems 104 are coupled to the host system 102 via one or more networks 106. Each user system 104 may be implemented using a general-purpose computer executing a computer program for carrying out the processes described herein. The user systems 104 may be personal computers (e.g., a lap top, a personal digital assistant) or host attached terminals. If the user systems 104 are personal computers, the processing described herein may be shared by a user system 104 and the host system 102 (e.g., by providing an applet to the user system 104). User systems 104 may be operated by authorized fluid members (e.g., general/limited partners).

The networks 106 may be ally type of known network including, but not limited to, a wide area network (WAN), a local area network (LAN), a global network (e.g. Internet), a virtual private network (VPN), and an intranet. The networks 106 may be implemented using a wireless network or any kind of physical networks implementation known in the art. A user system 104 may be coupled to the host system 102 through multiple networks (e.g., intranet and internet) so that not all user systems 104 are coupled to the host system 102 through the same network. One or more of the user systems 104 and the host system 102 may be connected to the networks 106 in a wireless fashion. In one embodiment, the networks include an intranet and one or more user systems 104 execute a user interface application (e.g. a web browser) to contact the host system 102 through the networks 106. In another exemplary embodiment, the user system 104 is connected directly (i.e., not though the networks 106) to the host system 102 and the host system 104 contains memory for storing data in support of the risk management functions. Alternatively, a separate storage device may be implemented for this purpose.

The internal storage of host system 102 (or alternatively, a storage device) includes a data repository with data relating to managing investments and investment-related risks and may be implemented using a variety of devices for storing electronic information. The storage is logically addressable as a consolidated data source across a distributed environment that includes networks 106. Information stored in the storage may be retrieved and manipulated via the host system 102 and/or via the user systems 104. The data repository includes one or more databases containing, e.g., aggregated commitments to one or more fluids, remaining available commitments for a given period of time, distributions made for the funds, total obligations, fund expenses, fund balances, formal balance sheets, summary sheets, and other related information. In addition, the repository may store fluid agreements among various investors and investment entities (e.g., entities in winch the investors have agreed to invest). The agreements may include a fund term (e.g., duration of the fund), minimum commitment level, etc.

The host system 102 depicted in the system of FIG. 1 may be implemented using one or more servers operating in response to a computer program stored in a storage medium accessible by the server. The host system 102 may operate as a network server (e.g., a web server) to communicate with the user systems 104. The host system 102 handles sending and receiving information to and from the user systems 104 and can perform associated tasks. The host system 102 may also include a firewall to prevent unauthorized access to the host system 102 and enforce any limitations on authorized access. For instance, an administrator may have access to the entire system and have authority to modify portions of the system. A firewall may be implemented using conventional hardware and/or software as is known in the art.

The host system 102 may also operate as an application server. The host system 102 executes one or more computer programs to provide risk management functions. These one or more applications are collectively referred to herein as a risk management application 108 and user interface. In addition, a spreadsheet application may also be implemented via the host system 102 and/or user systems 104. In one exemplary embodiment, the risk management application 108 collaborates with the spreadsheet application for communicating data (e.g., commitment/investment requests, threshold parameters, etc.) and generating summary sheets as described herein. Alternatively, the risk management application may include the functionality of a spreadsheet application.

As indicated above, processing may be shared by the user systems 104 and the host system 102 by providing an application (e.g., java applet) to the user systems 104. Alternatively, the user system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

The risk management application 108 implements the compliance model for performing the risk management activities described herein. As indicated above, the risk management application 108 may include a user interface for enabling one or more users (e.g., individuals of users systems 104) to enter criteria used by the risk management application 108 in processing fund information. For example, various activities associated with the fund may be monitored and managed by establishing threshold values defined by the users, which are applied to the fund data (e.g., commitments and other balance sheet data) and the guidelines provided by the risk management application 108. The activities may be actual ongoing activities or proposed activities as will be described further herein.

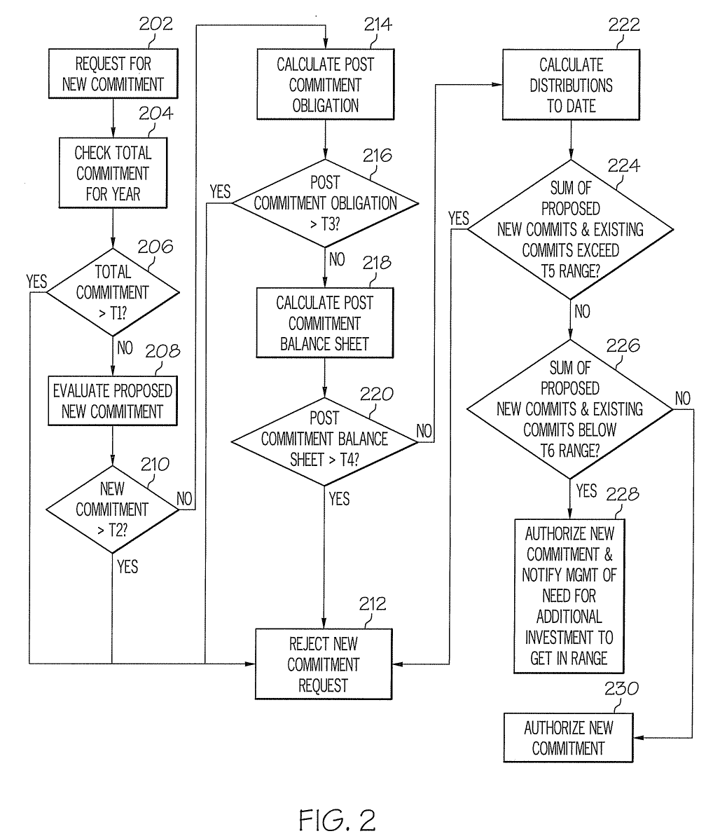

Turning now to FIG. 2, an exemplary process for implementing the risk management services will now be described. FIG. 2 describes a process for managing commitments (also referred to herein as “investments”) for a fund.

At step 202, a request for a new commitment is received. In exemplary embodiments, a commitment refers to an amount of money pledged by an individual or entity to the fund. In addition, a commitment may refer to a capital rollover of the fluid, which results from distributions, or income, received from the fund over time. If the commitment request relates to a capital rollover of the fund, the commitment amount may be determined/triggered based upon a recent distribution. Entry of the distribution into the storage of host system 102 may be identified by the risk management application 108 for use in generating the commitment request. If initiated by an individual, the commitment request may be entered by the individual, e.g., via the user interface of the risk management application 108, or may be an automated function. As an automated function, the risk management application 108 monitors activities conducted regarding the fund and periodically submits commitment requests. Alternatively, the commitment requests may be automatically generated based on pre-defined criteria established by the fund managers (e.g., general partners).

At step 204, the total commitment for the year is determined. In exemplary embodiments, the total commitment for the year refers to the amount of money committed to the fluid to date for the current year. As part of the disciplined approach to managing fund compliance, the risk management application 108 enables authorized users to establish a threshold specifying a maximum annual commitment (referred to herein as “threshold1” or “T1”) via, e.g., the user interface component of application 108.

At step 206, it is determined whether the total commitment for the year to date (or other pre-established time period), including the proposed new commitment, is greater than the pre-defined threshold (i.e., maximum annual commitment, or “T1”). If so, the request for the new commitment is rejected at step 212. Otherwise, if the total commitment for the year plus the proposed new commitment is less than or equal to the maximum annual commitment at step 206, then the proposed new commitment opportunity is considered for the fund.

At step 208, the proposed new commitment amount is received and evaluated. At step 210, it is determined whether the proposed new commitment amount is greater than a pre-defined threshold value (referred to herein as “threshold2”, or “T2”). The risk management application 108 enables authorized users to specify a minimum and/or maximum individual investment (e.g., an investment directed to a single enterprise). Threshold2 refers to a maximum allowable individual investment amount. If the amount of the commitment request exceeds this threshold value at step 210, the request for new commitment is denied at step 212.

If the requested new commitment amount is less than or equal to the threshold value (i.e., threshold2, or “T2”), then a current total post commitment obligation is calculated at step 214. The post commitment obligation may be derived by the total obligation (i.e., balance sheet commitments at the beginning of the current year) and factoring in year-to-date activities including drawdowns, divestments, commitments, distributions, writedowns, and proposed new commitments. At step 216, it is determined whether the total post commitment obligation exceeds a pre-defined maximum allowable total obligation. The maximum total obligation is referred to herein as threshold3 and may be provided by a user of the risk management application 108. If the total post commitment obligation exceeds the maximum total obligation (i.e., threshold3, or “T3”) at step 216, then the new commitment request is rejected at step 212.

If, however, the total post commitment obligation is less than or equal to the maximum total obligation (i.e., threshold3) at step 216, then a balance sheet post commitment value is calculated at step 218. The balance sheet post commitment value reflects the balance sheet commitments at the beginning of the current year, factoring in activities including drawdowns, offset by distributions and writedowns. This balance sheet post commitment value may be used by the risk management functions to assess an exposure risk level. The risk management functions enable a user to establish a maximum balance sheet exposure risk value in order to minimize investment risk. This maximum balance sheet exposure risk value is referred to herein as threshold4, or “T4”. At step 220, it is determined whether the balance sheet post commitment value is greater than the maximum balance sheet exposure risk value. If so, the request for new commitment is rejected at step 212.

If, however, the balance sheet post commitment value is less than or equal to the maximum balance sheet exposure risk value (“T4”) at step 220, then the find distributions to date are evaluated at step 222. Distributions refer to the payment of realized capital gains derived from investments in a fluid. At step 224, it is determined whether the sum of the commitment request amount plus existing new commitments falls below a pre-defined range (e.g., 30%) of the distribution total. This pre-deffied upper range is referred to herein as threshold5, or “T5”. The compliance model establishes this range criteria to ensure that all new commitments are funded by proceeds received from prior commitments, below the specified range. The particular upper range may be determined by studying prior patterns of when and how distributions/proceeds are received. By applying this range, the risk management application 108 ensures that the guidelines of the compliance model are not so stringent that they restrict appropriate investments made within a given time period. This range may be provided by an authorized individual of the fluid via, e.g., the user interface and user system 104. If the sum of the commitment request amount plus existing new commitments exceeds the pre-defined range of the distribution total at step 224, the commitment request is denied at step 212.

If, however, the stun of the commitment request plus existing new commitments is at or below the pre-defined upper range of the distribution total at step 224, it is then determined whether the sum of the requested commitment amount plus existing new commitments is within a pre-defined lower range of the stun of the commitment request amount plus total distributions at step 226. This lower range is referred to herein as threshold6, or “T6”. The lower range is utilized to notify fluid managers (e.g., via user systems 104) when pace of new investment is lagging and may put future returns at risk. If the sum of the requested commitment amount plus existing new commitments is not within the pre-defined lower range at step 226, the new commitment request is approved at step 228 and management is notified of possible future returns at risk. Otherwise, if the stun of the requested commitment amount plus existing new commitments is within the pre-defined deviation range at step 226, the new commitment request is approved at step 230. The commitment request may be executed and the balance sheet updated to reflect these activities.

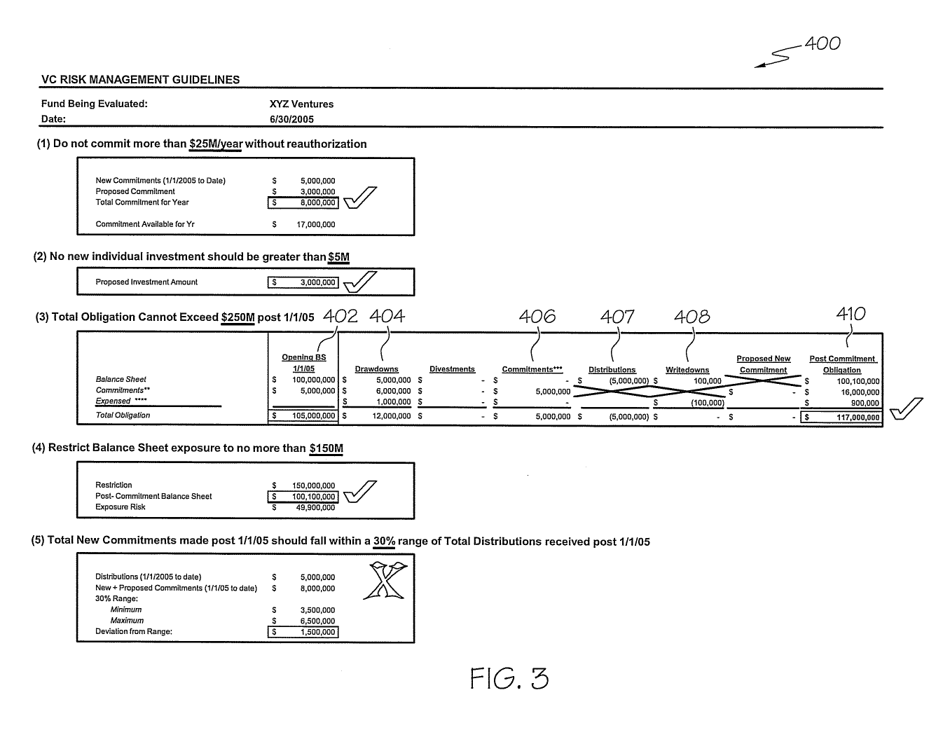

As indicated above, the compliance model also provides a snapshot of the balance sheet at any point in time. The snapshot is captured in a summary that is generated via the risk management application 108. A summary sheet 400 with sample data for a fluid “XYZ Ventures” is shown in FIG. 3. In exemplary embodiments, the summary sheet 400 is comprised of five portions reflecting the operative features and guidelines of the risk management functions. For purposes of illustration, the evaluation date for this fluid is Jun. 30, 2005. The first guideline specifies a maximum annual commitment (i.e., threshold1) of $25 million. A proposed commitment of $3 million is offered which, if approved, would bring the total new commitments to $8 million for the year (e.g., from Jan. 1, 2005 through Jun. 30, 2005). This proposed commitment may be tentatively approved (pending further evaluation of the guidelines) since the sun of this proposed commitment and the year-to-date commitments do not exceed the threshold of $25 million as shown in FIG. 3.

A second guideline in the summary sheet 400 specifies that no new individual investment should be greater than $5 million (i.e., maximum individual investment value, or “T2”). A third guideline in summary sheet 400 indicates that the find's total obligation may not exceed $250 million. The opening balance sheet as of Jan. 1, 2005 indicates a balance of $100 million in column 402. The opening balance does not change except for at the beginning of each new year. As shown in column 402 of FIG. 3, $5 million reflects the total commitments on Jan. 1, 2005 and is also a static figure that is changed only on the first day of each year. In column 404, $6 million represents the total amount of drawdowns occurring from Jan. 1, 2005 to Jun. 30, 2005. Of this $6 million, $5 million was applied to the balance sheet (reflected above in column 404) and $1 million was expensed (reflected below in column 404). Column 406 indicates that a total of $5 million has been committed from Jan. 1, 2005 to Jun. 30, 2005. Column 407 reflects the total distributions from Jan. 1, 2005 to Jun. 30, 2005. It is a negative number because it has been subtracted from the balance sheet in the row calculation. Column 408 reflects the total writedowns taken each quarter from Jan. 1, 2005 through Jun. 30, 2005. Column 410 (i.e., $117,000,000) reflects the total obligation at any point in time and, per the guidelines, cannot exceed $250 million (i.e., pre-defined threshold, or “T3”).

A fourth guideline in the summary sheet 400 specifies that the balance sheet exposure is to be restricted to no more than $150 million. This figure is taken from the third guideline (i.e., the post-commitment balance sheet reflects $100,100,000 in column 410).

A fifth guideline in the summary sheet 400 specifies that total new commitments made after Jan. 1, 2005 should fall with in a 30% upper range of the total distributions (threshold5, or “T5”) received from Jan. 1, 2005 through Jun. 30, 2005. As shown in FIG. 3, there is a deviation of $1,500,000 from the specified range (i.e., exceeding the 30% upper range threshold). As all new investments are required to be funded by distributions received (within a 30% range), the risk management application 108 will recommend rejecting the proposed new investment in XYZ Ventures. Alternatively, a further guideline may be applied to evaluate whether the total new commitments fall within a 10-15% lower range of the total distributions as described above with respect to FIG. 2. It will be understood that the summary sheet 400 may be configured to include other data types as desired. Actions resulting from the processes described in FIG. 2 cause the risk management application 108 to update this summary sheet 400, which may be accessible to authorized individuals at user systems 104.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiling or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer-implemented method for risk management, comprising:
establishing guidelines for processing commitment-related activities for all investment fund;
establishing criteria and threshold values for triggering events associated with the commitment-related activities;
applying the guidelines, the criteria, and the threshold values to data supplied by the investment fund; and
determining a course of action based upon application of the guidelines, criteria, and threshold values to the data.

2. The computer-implemented method of claim 1, wherein the guidelines include reviewing a proposed new commitment in view of existing total commitments for a given time period; and
wherein establishing threshold values includes specifying a maximum allowable commitment for the time period; and
wherein the course of action includes rejecting the proposed new commitment when the sum of the proposed new commitment and the existing total commitments for the time period is greater than the maximum allowable commitment for the time period.

3. The computer-implemented method of claim 1, wherein the guidelines include reviewing a proposed new commitment in view of a maximum allowable individual investment amount; and
wherein establishing threshold values includes specifying the maximum allowable individual investment amount for the investment fluid; and
wherein the course of action includes rejecting the proposed new commitment when the proposed new commitment exceeds the maximum allowable investment amount for the investment fluid.

4. The computer-implemented method of claim 1, wherein the guidelines include determining a total post commitment obligation derived from the total obligation factoring in year-to-date activities for the investment fund; and
wherein establishing threshold values includes specifying a maximum allowable total obligation; and
wherein the course of action includes rejecting a proposed new commitment when the total post commitment obligation exceeds the maximum allowable total obligation.

5. The computer-implemented method of claim 1, wherein the guidelines include:
calculating a balance sheet post commitment value derived from balance sheet commitments at the beginning of a time period factoring in balance sheet activities occurring during the time period; and
assessing an exposure risk value from the balance sheet post commitment value;
wherein establishing threshold values includes specifying a maximum allowable balance sheet exposure risk value; and
wherein the course of action includes rejecting a proposed new commitment when the balance sheet post commitment value exceeds the maximum allowable balance sheet exposure risk value.

6. The computer-implemented method of claim 1, wherein the guidelines include:
reviewing a distribution total for a time period;
summing a proposed new commitment and existing total commitments for the time period; and
reviewing results of the summing in view of the distribution total;
wherein establishing threshold values includes specifying a maximum upper range of the distribution total; and
wherein the course of action includes rejecting the proposed new commitment when the stun of the proposed new commitment and the existing total commitments exceeds the maximum upper range of the distribution total.

7. The computer-implemented method of claim 6, further comprising:
establishing a lower range of the distribution total;
wherein the course of action includes approving the proposed new commitment when the stun of the proposed new commitment and the existing total commitments is less than or equal to the maximum upper range of the distribution total; and
wherein further, the course of action includes notifying a fluid management entity when the stun of the proposed new commitment and the existing total commitments is below the lower range of the distribution total.

8. The computer-implemented method of claim 1, further comprising:
executing the course of action;
updating a balance sheet to reflect execution of the course of action; and
generating a summary sheet reflecting results of the execution on the balance sheet for the investment fund.

9. A system for providing risk management, comprising:
a host system; and
a risk management application and user interface executing on the host system, the risk management application implementing a method via the user interface, comprising:
establishing guidelines for processing commitment-related activities for an investment fluid;
establishing criteria and threshold values for triggering events associated with the commitment-related activities;
applying the guidelines, the criteria, and the threshold values to data supplied by the investment fund; and
determining a course of action based upon application of the guidelines, criteria, and threshold values to the data.

10. The system of claim 9, wherein the guidelines include reviewing a proposed new commitment in view of existing total commitments for a given time period; and
wherein establishing threshold values includes specifying a maximum allowable commitment for the time period; and
wherein the course of action includes rejecting the proposed new commitment when the sum of the proposed new commitment and the existing total commitments for the time period is greater than the maximum allowable commitment for the time period.

11. The system of claim 9, wherein the guidelines include reviewing a proposed new commitment in view of a maximum allowable individual investment amount; and
wherein establishing threshold values includes specifying the maximum allowable individual investment amount for the investment fund; and
wherein the course of action includes rejecting the proposed new commitment when the proposed new commitment exceeds the maximum allowable investment amount for the investment fund.

12. The system of claim 9, wherein the guidelines include determining a total post commitment obligation derived from the total obligation factoring in year-to-date activities for the investment fund; and
wherein establishing threshold values includes specifying a maximum allowable total obligation; and
wherein the course of action includes rejecting a proposed new commitment when the total post commitment obligation exceeds the maximum allowable total obligation.

13. A computer program product for providing risk management, the computer program product including instructions for causing a computer to implement a method, comprising:
establishing guidelines for processing commitment-related activities for an investment fluid;
establishing criteria and threshold values for triggering events associated with the commitment-related activities;
applying the guidelines, the criteria, and the threshold values to data supplied by the investment fund; and
determining a course of action based upon application of the guidelines, criteria, and threshold values to the data.

14. The computer program product of claim 13, wherein the guidelines include reviewing a proposed new commitment in view of existing total commitments for a given time period; and
wherein establishing threshold values includes specifying a maximum allowable commitment for the time period; and
wherein the course of action includes rejecting the proposed new commitment when the sum of the proposed new commitment and the existing total commitments for the time period is greater than the maximum allowable commitment for the time period.

15. The computer program product of claim 13, wherein the guidelines include reviewing a proposed new commitment in view of a maximum allowable individual investment amount; and
wherein establishing threshold values includes specifying the maximum allowable individual investment amount for the investment fund; and
wherein the course of action includes rejecting the proposed new commitment when the proposed new commitment exceeds the maximum allowable investment amount for the investment fund.

16. The computer program product of claim 13, wherein the guidelines include determining a total post commitment obligation derived from the total obligation factoring in year-to-date activities for the investment fund; and
wherein establishing threshold values includes specifying a maximum allowable total obligation; and
wherein the course of action includes rejecting a proposed new commitment when the total post commitment obligation exceeds the maximum allowable total obligation.

17. The computer program product of claim 13, wherein the guidelines include:
calculating a balance sheet post commitment value derived from balance sheet commitments at the beginning of a time period factoring in balance sheet activities occurring during the time period; and
assessing an exposure risk value from the balance sheet post commitment value;
wherein establishing threshold values includes specifying a maximum allowable balance sheet exposure risk value; and
wherein the course of action includes rejecting a proposed new commitment when the balance sheet post commitment value exceeds the maximum allowable balance sheet exposure risk value.

18. The computer program product of claim 13, wherein the guidelines include:
reviewing a distribution total for a time period;
summing a proposed new commitment and existing total commitments for the time period; and
reviewing results of the summing in view of the distribution total;
wherein establishing threshold values includes specifying a maximum upper range of the distribution total; and
wherein the course of action includes rejecting the proposed new commitment when the sum of the proposed new commitment and the existing total commitments exceeds the maximum upper range of the distribution total.

19. The computer program product of claim 18, further comprising instructions for causing the computer to implement:
establishing a lower range of the distribution total;
wherein the course of action includes approving the proposed new commitment when the sum of the proposed new commitment and the existing total commitments is less than or equal to the maximum upper range of the distribution total; and
wherein further, the course of action includes notifying a fund management entity when the stun of the proposed new commitment and the existing total commitments is below the lower range of the distribution total.

20. The computer program product of claim 13, further comprising instructions for causing the computer to implement:
executing the course of action;
updating a balance sheet to reflect execution of the course of action; and
generating a summary sheet reflecting results of the execution on the balance sheet for the investment fund.
